(19) United States
(12) Patent Application Publication
(10) Pub. No.: US 2021/0217398 A1
(43) Pub. Date: Jul. 15, 2021

(54) ACTIVE NOISE CONTROL

(71) Applicant: QUALCOMM Incorporated, San Diego, CA (US)

(72) Inventor: Senthil Raja Gunaseela Boopathy, Bangalore (IN)

(21) Appl. No.: 16/744,071

(22) Filed: Jan. 15, 2020

(51) Int. Cl. G10K 11/178; B25J 19/02; B64C 39/02

(52) U.S. Cl. CPC G10K 11/17823; G10K 2210/1281; B64C 39/024; B25J 19/026

(57) ABSTRACT

Methods, systems, and devices for active noise control associated with a mobile robot device are described. The methods, systems, and devices may include detecting ambient noise via one or more microphones of the mobile robot device, determining that the ambient noise satisfies a threshold by comparing one or more parameters of the ambient noise to the threshold based on detecting of the noise parameter, generating anti-noise based on determining that the ambient noise satisfies the threshold, and broadcasting the anti-noise in a first direction using one or more speakers of the mobile robot device.

### BACKGROUND

The following relates generally to audio devices, and more specifically to active noise control.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, audio systems, audiovisual systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

In some examples, multimedia systems may include noise-canceling headsets. In some examples, a user may wear a noise-canceling headset to cancel ambient noise around the user. In some examples, the noise-canceling headset may be comfortable for a time, but the noise-canceling headset may cause pain or irritation to the user (e.g., after the user wears the noise-canceling headset for a relatively long period of time), among other disadvantages.

### SUMMARY

The described techniques relate to improved methods, systems, devices, and apparatuses that support active noise control. Generally, the described techniques provide for active noise control free from the constraints and irritation of noise-canceling headsets. In some examples, the described techniques provide for active noise control in conjunction with a mobile robot device. Some noise-canceling systems are based on noise-canceling headsets, which provide noise canceling for a single person and can cause pain or irritation to a user after relatively long periods of time. Using a mobile robot device to detect noise and generate anti-noise provides noise canceling without pain or irritation to the user, along with other advantages, including more dynamic and adaptive noise cancelation. Also, using a mobile noise-canceling robot device provides noise canceling for one or more users within a vicinity of the noise-canceling robot device.

A method of active noise control associated with a mobile robot device is described. The method may include detecting ambient noise via one or more microphones of the mobile robot device, determining that the ambient noise satisfies a threshold by comparing one or more parameters of the ambient noise to the threshold based on detecting of the noise parameter, generating anti-noise based on determining that the ambient noise satisfies the threshold, and broadcasting the anti-noise in a first direction using one or more speakers of the mobile robot device.

An apparatus for active noise control associated with a mobile robot device is described. The apparatus may include a processor, memory coupled with the processor, and instructions stored in the memory. The instructions may be executable by the processor to cause the apparatus to detect ambient noise via one or more microphones of the mobile robot device, determine that the ambient noise satisfies a threshold by comparing one or more parameters of the ambient noise to the threshold based on detecting of the noise parameter, generate anti-noise based on determining that the ambient noise satisfies the threshold, and broadcast the anti-noise in a first direction using one or more speakers of the mobile robot device.

Another apparatus for active noise control associated with a mobile robot device is described. The apparatus may include means for detecting ambient noise via one or more microphones of the mobile robot device, determining that the ambient noise satisfies a threshold by comparing one or more parameters of the ambient noise to the threshold based on detecting of the noise parameter, generating anti-noise based on determining that the ambient noise satisfies the threshold, and broadcasting the anti-noise in a first direction using one or more speakers of the mobile robot device.

A non-transitory computer-readable medium storing code for active noise control associated with a mobile robot device is described. The code may include instructions executable by a processor to detect ambient noise via one or more microphones of the mobile robot device, determine that the ambient noise satisfies a threshold by comparing one or more parameters of the ambient noise to the threshold based on detecting of the noise parameter, generate anti-noise based on determining that the ambient noise satisfies the threshold, and broadcast the anti-noise in a first direction using one or more speakers of the mobile robot device.

Some examples of the method, apparatuses, and non-transitory computer-readable medium described herein may further include operations, features, means, or instructions for detecting a change in a signal strength of the ambient noise, and adjusting a signal strength of the anti-noise based on the detected change in the signal strength of the ambient noise.

Some examples of the method, apparatuses, and non-transitory computer-readable medium described herein may further include operations, features, means, or instructions for analyzing a first signal of the ambient noise detected by a first microphone of the one or more microphones relative to a second signal of the ambient noise detected by a second microphone of the one or more microphones, and determining a location of the ambient noise relative to the mobile robot device based on the analyzing of the first signal relative to the second signal, where generating the anti-noise may be based on determining the location of the ambient noise.

Some examples of the method, apparatuses, and non-transitory computer-readable medium described herein may further include operations, features, means, or instructions for determining a change in the location of the ambient noise, and broadcasting the anti-noise in a second direction based on the change in the location of the ambient noise.

Some examples of the method, apparatuses, and non-transitory computer-readable medium described herein may further include operations, features, means, or instructions for detecting, via a sensor on the mobile robot device, an object, and avoiding, based on the detecting, a collision between the mobile robot device and the object when adjusting a position of the mobile robot device in relation to the first direction.

Some examples of the method, apparatuses, and non-transitory computer-readable medium described herein may further include operations, features, means, or instructions for maintaining a determined range between the mobile robot device and a mobile computing device or between the mobile robot device and a user of the mobile computing device when adjusting a position of the mobile robot device in relation to the first direction.

Some examples of the method, apparatuses, and non-transitory computer-readable medium described herein may further include operations, features, means, or instructions for determining, via a camera on the mobile robot device, a face of the user or an identity of the user, or both, and maintaining the determined range between the mobile robot device and the user based on the determining.

Some examples of the method, apparatuses, and non-transitory computer-readable medium described herein may further include operations, features, means, or instructions for broadcasting audio concurrent with broadcasting the anti-noise using the one or more speakers of the mobile robot device.

In some examples of the method, apparatuses, and non-transitory computer-readable medium described herein, the mobile robot device may be an aerial drone.

In some examples of the method, apparatuses, and non-transitory computer-readable medium described herein, the one or more speakers include wireless speakers.

### BRIEF DESCRIPTION OF THE DRAWINGS

FIG. 1 illustrates an example of a system that supports active noise control in accordance with aspects of the present disclosure.

FIG. 2 illustrates another example of a system that supports active noise control in accordance with aspects of the present disclosure.

FIGS. 3 and 4 show block diagrams of devices that support active noise control in accordance with aspects of the present disclosure.

FIG. 5 shows a block diagram of a noise control manager that supports active noise control in accordance with aspects of the present disclosure.

FIG. 6 shows a diagram of a system including a device that supports active noise control in accordance with aspects of the present disclosure.

FIGS. 7 and 8 show flowcharts illustrating methods that support active noise control in accordance with aspects of the present disclosure.

### DETAILED DESCRIPTION

In some examples, a user may wear a noise-canceling headset to cancel ambient noise around the user. In some examples, the noise-canceling headset may be comfortable for a time, but eventually the noise-canceling headset may cause pain or irritation to the ears or head of the user after the user wears the noise-canceling headset for some time. Thus, the user may remove the noise-canceling headset to relieve the pain or irritation. However, when the user removes the noise-canceling headset, the user is then exposed to the ambient noise, which may limit a user's experience. Or alternatively, some noise cancellation headsets may not be configured to adequately to cancel ambient noise and other techniques and devices may be better able to solve these issues, among others.

In some examples, the described techniques include operations for active noise control by a mobile robot device. In some examples, the mobile robot device may include one or more microphones, or one or more speakers, or both. The one or more speakers may include wireless speakers (e.g., BLUETOOTH® speakers). In some examples, the one or more speakers may be configured to play anti-noise alone or anti-noise with audio (e.g., music, audio book, podcast, etc.). In some examples, the mobile robot device may use the one or more microphones located on the mobile robot device to detect ambient noise. The mobile robot device may generate anti-noise based on the detected ambient noise, and then play the anti-noise via the one or more speakers located on the mobile robot device.

In some examples, one or more other microphones (which may be associated with one or more other devices) may be able to detect ambient noise and the detected noise or related information may be conveyed to the mobile robot device for noise cancellation. The mobile robot device may, in some examples, use one or more microphones located remotely from the mobile robot device (e.g., one or more microphones located on a mobile device in the same room as the mobile robot device, etc.) to detect the ambient noise. In some examples, the mobile robot device may play the anti-noise via one or more speakers at the mobile robot device, or located remotely from the mobile robot device (e.g., one or more speakers located on a mobile device in the same room as the mobile robot device, etc.), or both.

In some examples, the mobile robot device may be communicatively coupled to a mobile device of a user. In some examples, the mobile device may include a user interface that enables the user to configure one or more aspects of the mobile robot device. For example, the user interface may enable the user to configure an area or space within which the mobile robot device is allowed to operate (e.g., an area or space within 1 foot, or 5, feet, or 10 feet, etc., of the user or of the mobile device). In some examples, the mobile robot device may include a camera to detect, recognize, and track the user and determine a distance to the user based at least in part on a captured image of the user (e.g., estimate distance based on size of user's head in the image). In some examples, the mobile robot device and camera may be calibrated to estimate the distance using a proximity detection, a visual detection, another method, or any combination thereof. In some examples, the mobile robot device may determine a distance based on communication between the mobile robot device and the mobile device. For example, a timing (e.g., roundtrip timing) of a communication or a signal may enable the mobile robot device to estimate a distance between the mobile robot device and the mobile device. The generation and initiation of the anti-noise via one or more speakers (e.g., at the mobile robot device) may be based on a distance of a user or a user device (or both) from the mobile robot device.

Aspects of the disclosure are initially described in the context of various examples of an active noise control system. Aspects of the disclosure are further illustrated by and described with reference to apparatus diagrams, system diagrams, and flowcharts that relate to active noise control.

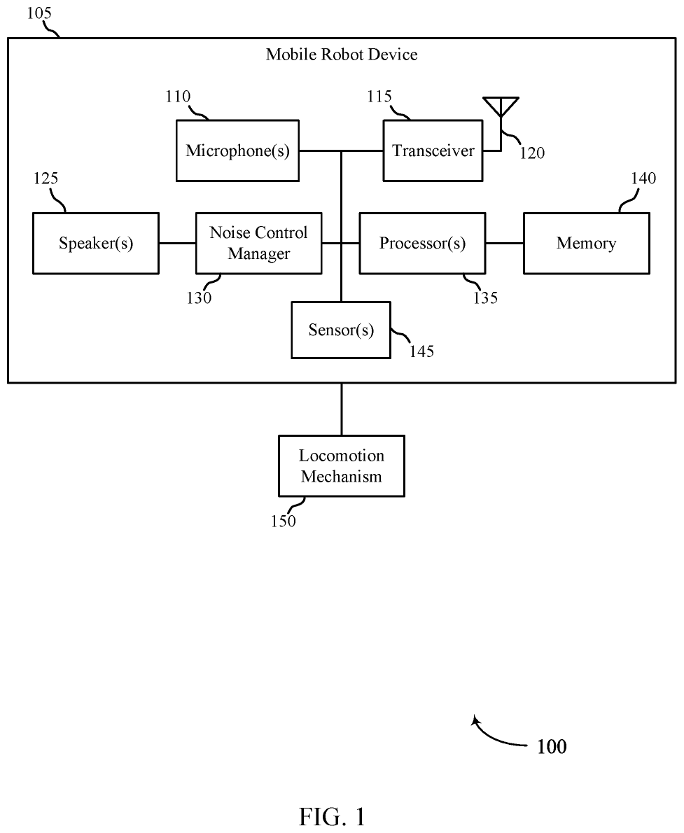

FIG. 1 illustrates an example of a system 300 that supports active noise control in accordance with aspects of the techniques described herein. In some examples, system 100 may include mobile robot device 105. In the illustrated example, mobile robot device 105 may include one or more microphones 110, transceiver 115, at least one antenna 120, one or more speakers 125, noise control manager 130, at least one processor 135, memory 140, at least one sensor 145, and locomotion component 150. Examples of sensor 145 may include at least one of one or more image sensors, one or more motion sensors, one or more proximity sensor, one or more gyroscope sensors, one or more accelerometers, one or more radar sensors, one or more light detection and ranging (LIDAR) sensors, one or more global positioning system (GPS) sensors, one or more local positioning system (LPS) sensors, one or more ultrasonic sensors, or any combination thereof. Examples of locomotion component 150 may include at least one of one or more wheels, or one or more propellers, or one or more wings, or one or more hovercraft airbags, or one or more hovercraft lift fans, or one or more legs, or one or more continuous tracks, or any combination thereof. In some examples, the locomotion component 150 may enable mobile robot device 105 to move in a variety of ways. In some examples, locomotion component 150 may include wheels, or continuous tracks, or hovercraft airbags, or any combination thereof to move mobile robot device 105 along a surface (e.g., along a floor of a room, along a table, along a countertop, along a vertical wall, along a ceiling, etc.). In some examples, locomotion component 150 may include an adherence device that enables locomotion component 150 to adhere to and move along a vertical surface or an inverted surface (e.g., ceiling). The adherence device may include magnets to adhere to ferro-magnetic surfaces, claws to hook onto vertical or inverted surfaces, adhesive pads to hold onto vertical or inverted surfaces, etc. In some examples, locomotion component 150 may move mobile robot device 105 to a location on the surface based on noise that mobile robot device 105 detects.

In some examples, locomotion component 150 may move mobile robot device 105 to the location to enable mobile robot device 105 to play anti-noise at the location that minimizes or cancels the noise. In some examples, locomotion component 150 may move mobile robot device 105 to the location based at least in part on mobile robot device 105 determining the anti-noise is most effective at minimizing the noise when played at the location. In some examples, locomotion component 150 may move mobile robot device 105 to several locations to determine which of the several locations provides the greatest reduction to the noise based on the mobile robot device 105 playing the anti-noise at each of the several locations and determining a level of noise reduction at each of the several locations. Accordingly, locomotion component 150 may move mobile robot device 105 to the location that mobile robot device 105 determines to provide the greatest reduction to the noise.

In some examples, noise control manager 130 of mobile robot device 105 may include at least one of hardware (e.g., customized processors, customized memory, customized storage), or firmware (e.g., customized drivers that enable noise control manager 130 to interface with hardware of mobile robot device 105), or software (e.g., customized software code, customized software applications, customized user interfaces, etc.), or any combination thereof.

In some examples, mobile robot device 105 may be configured to provide active noise control. In some examples, the one or more microphones 110 may be configured to detect sounds. In some examples, the one or more processors 135 may be configured to analyze the sound detected by the one or more microphones 110.

In some examples, the one or more processors 135 may be configured to determine whether the sound detected by the one or more microphones 110 includes a noise. In some examples, the noise may include an indoor noise (e.g., a fan, an appliance, television, radio, people conversing, etc.), or an outside noise or street noise (e.g., vehicle noise, machine noise, people conversing, etc.), and the like. In some examples, the one or more microphones 110 may generate one or more sound signals or noise signals that represent an analog or digital version of the sound or noise detected by the one or more microphones 110.

In some examples, when the one or more processors 135 determine that the detected sound includes a noise, the one or more processors 135 may determine whether the noise exceeds a determined threshold (e.g., a threshold of 30 decibels, or 40 decibels, or 50 decibels, or 60 decibels, etc.).

In some examples, when the one or more processors 135 determine that the noise exceeds the determined threshold, the noise control manager 130 may generate an anti-noise signal. In some examples, one or more operations of the noise control manager 130 may be performed in conjunction with the one or more processors 135.

In some examples, the noise control manager 130 may determine one or more aspects of the detected sound or noise. For example, the noise control manager 130 may identify an amplitude and phase associated with the detected sound or noise. In some examples, the noise control manager 130 may configure an amplitude and phase of the anti-noise signal based at least in part on the identified amplitude and phase associated with the detected sound or noise. In some examples, the noise control manager 130 may configure the amplitude of the anti-noise signal to have a given relationship to (e.g., match, exceed) the amplitude of the detected sound or noise. In some examples, the noise control manager 130 may configure the phase of the anti-noise signal (e.g., antiphase) based at least in part on an inverted phase of the detected sound door noise. Accordingly, the amplitude of the anti-noise may match the amplitude of the detected sound or noise, while the phase of the anti-noise may be inverted (e.g., 180 degrees out of phase) in relation to the phase of the detected sound or noise.

In some examples, the noise control manager 130 may generate the anti-noise signal whether or not the noise exceeds a determined threshold. In some examples, the noise control manager 130 may generate the anti-noise signal for any sound detected by the one or more microphones 110.

In some examples, the noise control manager 130 may output (e.g., broadcast) the anti-noise signal through the one or more speakers 125. In some examples, the noise control manager 130 outputting the anti-noise signal through the one or more speakers 125 may include the one or more speakers 125 emitting a sound wave with an amplitude, such as the same amplitude as the detected sound or noise, but with a different phase (e.g., an inverted phase of the detected sound or noise), resulting in at least a portion of the detected sound or noise being canceled.

In some examples, the noise control manager 130 may generate a map of an area or space. In some examples, the noise control manager 130 may generate the map based at least in part on user input. In some examples, the noise control manager 130 may generate the map based at least in part on a scan of the area or space by the one or more sensors 145. In some examples, the map may indicate at least one of a location of a window, or a location of a door, or a location of a wall, or a location of a piece of furniture, or any combination thereof. In some examples, the noise control manager 130 may instruct the locomotion component 150 to move the mobile robot device 105 in a particular direction or to a particular location. In some examples, the noise control manager 130 may instruct the locomotion component 150 to move the mobile robot device 105 in a particular direction or to a particular location based at least in part on information from the map, or based on a direction or location of a source of sound or noise, or both. In some examples, the noise control manager 130 may instruct the locomotion component 150 to avoid an obstacle indicated by the map (e.g., a wall, a piece of furniture, a window, etc.) when moving the mobile robot device 105.

In some examples, the noise control manager 130 may instruct the locomotion component 150 to move the mobile robot device 105 in a particular direction or to a particular location in conjunction with the noise control manager 130 outputting the anti-noise signal through the one or more speakers 125. For example, the noise control manager 130 may instruct the locomotion component 150 to move the mobile robot device 105 in a particular direction or to a particular location to improve cancellation of the detected sound or noise.

In some examples, the noise control manager 130 may determine a location of the detected sound or noise. In some examples, the noise control manager 130 may instruct the locomotion component 150 to move the mobile robot device 105 in a particular direction or to a particular location based at least in part on the determined location of the detected sound or noise. For example, mobile robot device 105 located in a room with a window may detect noise coming in from the window. After determining a direction of the noise, locomotion component 150 may move mobile robot device 105 to one or more locations in the room and play anti-noise at each of the one or more locations to determine which location provides the greatest reduction to the noise. Locomotion component 150 may then move mobile robot device 105 to the location that provides the greatest reduction to the noise.

In some examples, the noise control manager 130 may determine the location of the detected sound or noise based at least in part on noise control manager 130 performing one or more acoustic location operations (e.g., sound triangulation, sound location analysis, sound diffraction, etc.). In some examples, the noise control manager 130 performing the one or more acoustic location operations may include the noise control manager 130 analyzing a first noise signal generated or detected by a first microphone of the one or more microphones 110 in relation to at least a second noise signal generated or detected by at least a second microphone of the one or more microphones 110. In some examples, the noise control manager 130 performing the one or more acoustic location operations may include the noise control manager 130 detecting a first timing differential based at least in part on the noise control manager 130 comparing a first timing signature of a first noise signal detected by a first microphone with a second timing signature of a second noise signal detected by a second microphone. In some examples, the noise control manager 130 performing the one or more acoustic location operations may include the noise control manager 130 detecting a second timing differential based at least in part on the noise control manager 130 comparing a first timing signature of the first noise signal detected by a first microphone with a third timing signature of a third noise signal detected by a third microphone. In some examples, the noise control manager 130 performing the one or more acoustic location operations may include the noise control manager 130 detecting a third timing differential based at least in part on the noise control manager 130 comparing the second timing signature of the second noise signal detected by the second microphone with the third timing signature of the third noise signal detected by the third microphone. In some examples, the noise control manager 130 may determine a location of the detected sound or noise based at least in part on the first timing differential, or the second timing differential, or the third timing differential, or any combination thereof. In some examples, a timing signature (e.g., first timing signature, second timing signature, third timing signature, etc.) of a noise signal detected by a microphone of the one or more microphones 110 may be based at least in part on a time of arrival of a portion of the detected sound or noise at the microphone.

In some examples, the noise control manager 130 may determine a location of a mobile computing device. In some examples, the noise control manager 130 may determine a location of a user of the mobile computing device. In some examples, the noise control manager 130 may instruct the locomotion component 150 to move the mobile robot device 105 in a particular direction or to a particular location based at least in part on the determined location of the mobile computing device, or the determined location of the user, or both. In some examples, the noise control manager 130 may instruct the locomotion component 150 to move the mobile robot device 105 in a particular direction or to a particular location based at least in part on the determined location of the mobile computing device or the determined location of the user, or both, to improve cancellation of the detected sound or noise.

In some examples, the noise control manager 130 may use the one or more sensors 145 to determine a location of the mobile computing device, or a location of the user, or both. For example, the noise control manager 130 may use an image sensor of the one or more sensors 145 to recognize a face of the user or use the one or more microphones 110 to recognize a voice of the user. In some examples, may determine a location of the user based at least in part on recognizing the face of the user or recognizing the voice of the user, or both. In some examples, the mobile computing device may emit one or more sounds (e.g., sounds outside a human hearing range), and the noise control manager 130 may detect, in conjunction with the one or more microphones 110, the one or more emitted sounds from the mobile computing device and determine the location of the mobile computing device based at least in part on one or more timing differentials associated with the noise control manager 130 analyzing the one or more sounds emitted by the mobile computing device. In some examples, the noise control manager 130 may detect, in conjunction with the one or more sensors 145, one or more signals emitted by the mobile computing device (e.g., one or more wireless signals, one or more cellular signals, one or more near-field signals, etc.) And determine a location of the mobile computing device based at least in part on an analysis of the detected one or more signals emitted by the mobile computing device (e.g., triangulation analysis of the emitted signals).

In some examples, the noise control manager 130 may instruct the locomotion component 150 to move the mobile robot device 105 in a particular direction or to a particular location to calibrate cancellation of the detected sound or noise. In some examples, the noise control manager 130 may request a first feedback from a user (e.g., via an interface of a mobile computing device of the user) after the locomotion component 150 moves the mobile robot device 105 in a first direction or to a first location. In some examples, the noise control manager 130 may request at least a second feedback from the user after the locomotion component 150 moves the mobile robot device 105 in at least a second direction or to at least a second location. In some examples, the noise control manager 130 may determine, based at least in part on the first feedback and at least the second feedback, that the first direction or first location provides improved noise cancellation compared to at least the second direction or second location. Accordingly, the noise control manager 130 may instruct the locomotion component 150 to move the mobile robot device 105 to the first direction or first location the noise control manager 130 determining the first direction or first location provides improved noise cancellation according to the first feedback and at least the second feedback.

In some examples, the noise control manager 130 a may receive the feedback from a mobile computing device via the at least one antenna 120 and transceiver 115. In some examples, the mobile computing device may include one or more microphones. In some examples, the mobile computing device may measure a sound level via the one or more microphones of the mobile computing device. In some examples, the mobile computing device may provide feedback (e.g., sound levels measured by the microphones of the mobile computing device) to the noise control manager 130 based at least in part on the noise control manager 130 performing active noise control at one or more locations or in one or more directions, or both (e.g., the first location and at least in the second location, or in the first direction and at least in the second direction, or any combination thereof). In some examples, the noise control manager 130 may determine, based at least in part on the feedback from the mobile computing device, that the first direction or the first location provides improved noise cancellation compared to at least the second direction or second location. Accordingly, the noise control manager 130 may instruct the locomotion component 150 to move the mobile robot device 105 to the first direction or first location based at least in part on the noise control manager 130 determining the first direction or first location provides improved noise cancellation according to the feedback from the mobile computing device.

Accordingly, mobile robot device 105 may enable a user to occupy an area or space (e.g., move around the area or space) relatively free from ambient noise of the area or space without having to wear a noise-canceling headset.

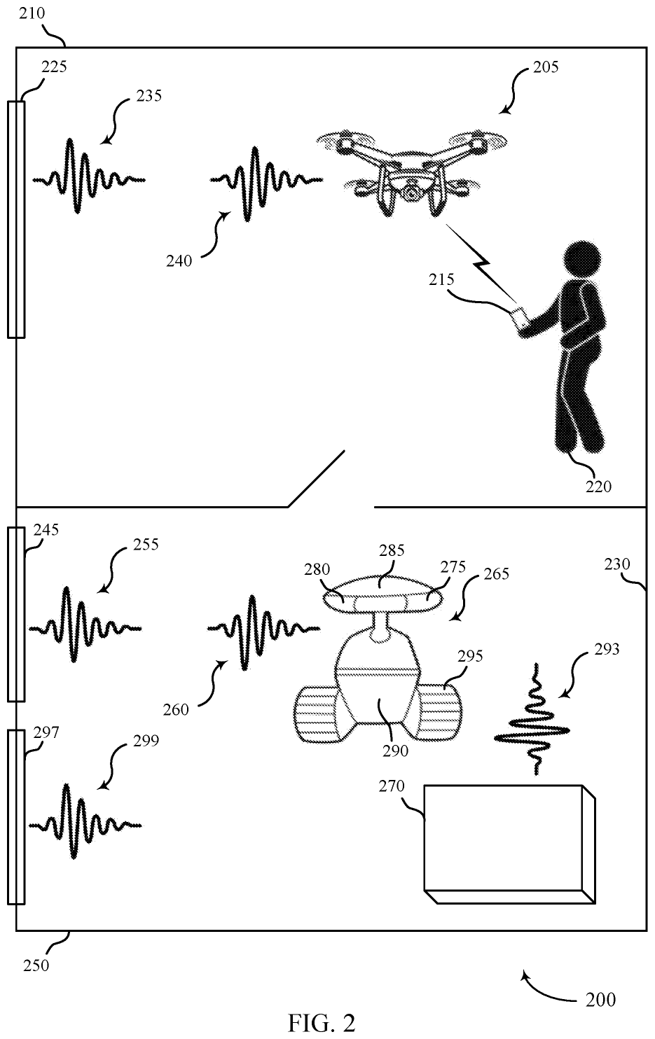

FIG. 2 illustrates an example of a system 200 that supports active noise control in accordance with aspects of the present disclosure. In some examples, system 200 may implement aspects of active noise system 100.

As depicted, system 200 may include a first room 210 and a second room 250 of a premises (e.g., a room or area of a home, a room or area of a business office, a room or area of a school, a room or area of a library, a room or area of a hospital, etc.).

In some examples, the first room 210 may include one or more rooms. In the illustrated example, the first room 210 may include a mobile robot device 205, a mobile computing device 215, a user 220, a window 225, and second room 250 may include mobile robot device 265, first window 245, second window 297, object 270, and a wall 230. Examples of object 270 may include furniture (e.g., table, chair, couch, piano, bookcase, appliance, etc.).

In some examples, the mobile robot device 205 or mobile robot device 265 may include an aerial drone configured to move to a location in space and play anti-noise at the location based on an analysis of the noise being canceled. In some examples, the mobile robot device 205 or mobile robot device 265 may include a ground robot device configured to move on a surface, such as a floor, a wall, a ceiling, or any combination thereof. The mobile robot device 205 may be an example of the mobile robot device 105 of FIG. 1.

As shown, noise 235 may enter the first room 210 via window 225. In some examples, one or more other noises in addition to noise 235 may enter the first room 210 (e.g., via a door of first room 210, from another room or area adjacent to or relatively near first room 210, or another premises adjacent to or relatively near first room 210, etc.).

In some examples, the mobile robot device 205 may detect the noise 235. In some examples, the mobile robot device 205 may generate an anti-noise signal based at least in part on the detection of the noise 235. In some examples, the mobile robot device 205 may emit anti-noise 240 based at least in part on the mobile robot device 205 generating the anti-noise signal.

In some examples, the mobile robot device 205 may determine whether the noise 235 exceeds a determined threshold (e.g., exceeds a noise level threshold). In some examples, the mobile robot device 205 may generate the anti-noise signal based at least in part on the determination that the noise 235 exceeds the determined threshold.

In some examples, the mobile robot device 205 may determine that a measured level of the noise 235 drops below the determined threshold. In some examples, the mobile robot device 205 may cease emitting the anti-noise 240 based at least in part on the determination that the measured level of the noise 235 dropped below the determined threshold.

In some examples, the mobile robot device 205 may determine a direction associated with or a the location of the noise 235, or both. For example, the mobile robot device 205 may determine that the noise 235 is coming from a source outside of the window 225 or from a source direction in front of the window 225. In some examples, the mobile robot device 205 may move relative to the window 225 (e.g., closer to the window 225, farther from the window 225, move vertically relative to the window 225, ascend or descend a wall in relation to the window 225, move along a ceiling relative to the window 225, etc.) based at least in part on the determined location of the noise 235. In some examples, the mobile robot device 205 may adjust an aspect of the anti-noise 240 (e.g., an amplitude of the anti-noise 240 or a phase of the anti-noise 240, or both) based at least in part on the mobile robot device 205 moving relative to the window 225.

In some examples, the mobile robot device 205 may detect the user 220 leaving first room 210 (e.g., user exits first room 210 and enters second room 250). In some examples, mobile robot device 205 may track and follow user 220 out of first room 210 and into second room 250. In some examples, mobile robot device 205 may detect noise in second room 250 (e.g., noise 255 from first window 245) and adjust the generation of anti-noise 240 based on the noise mobile robot device 205 detects in the second room 250. In some examples, noise 255 may be from the same source or a different source as noise 235.

In some examples, the mobile robot device 205 may cease emitting the anti-noise 240 based at least in part on the determination that the user 220 has left first room 210. In some examples, the mobile robot device 205 may at least partially deactivate (e.g., bring the mobile robot device 205 from a higher power state, such as a flying state, to a lower power state, such as a landing state on a surface of first room 210, stop adjusting a direction or location of the mobile robot device 205, put the mobile robot device 205 into a low power state, other actions, or any combination thereof) based at least in part on the determination that the user 220 has left first room 210.

In some examples, the mobile robot device 205 may detect the user 220 entering first room 210. In some examples, the mobile robot device 205 may at least partially activate (e.g., at least partially reactivate) based at least in part on the determination that the user 220 has entered (e.g., reentered) first room 210. In some examples, the mobile robot device 205 may emit the anti-noise 240 (e.g., start again to emit the anti-noise 240) based at least in part on the determination that the user 220 has entered (e.g., reentered) first room 210.

In some examples, mobile robot device 265 may detect the user 220 entering second room 250. In some examples, the mobile robot device 265 may at least partially activate (e.g., at least partially reactivate) based at least in part on the determination that the user 220 has entered (e.g., reentered) second room 250. In some examples, the mobile robot device 265 may emit anti-noise 260 (e.g., start again to emit the anti-noise 260) based at least in part on the determination that the user 220 has entered (e.g., reentered) second room 250.

In some examples, mobile robot device 265 may move around on a surface of second room 250 (e.g., wall 230, floor of second room 250, ceiling of second room 250, surface of object 270, etc.). In some examples, mobile robot device 265 may move via locomotion component 295 (e.g., one or more wheels, one or more tracks, etc.).

In the illustrated example, mobile robot device 265 may include first microphone 275, second microphone 280, first speaker 285, and second speaker 290. In some examples, mobile robot device 265 may detect noise 255 based at least in part on mobile robot device 265 using first microphone 275 or second microphone 280, or both, to monitor for noise in second room 250. In some examples, mobile robot device 265 may output anti-noise 260 via first speaker 285 or second speaker 290, or both.

In some examples, mobile robot device 265 may determine a type of noise associated with noise 255 or noise 299, or another noise (e.g., sound from a radio, sound from a television, sound from a telephone, sound from a smartphone, etc.). In some examples, mobile robot device 265 may generate anti-noise 260 to minimize or cancel noise 255 while canceling sound from another source such as a television, etc. For example, mobile robot device 265 may detect sound 293 from object 270. In some examples, mobile robot device 265 may identify one or more frequencies associated with sound 293. In some examples, mobile robot device 265 may minimize frequencies from noise 255 while permitting frequencies from sound 293. For example, mobile robot device 265 may detect a first frequency in noise 255 and a second frequency in sound 293 different from the first frequency. In some examples, mobile robot device 265 may generate and include an inverse signal of the first frequency from noise 255 in anti-noise 260 to cancel out the first frequency, while excluding an inverse of the second frequency in anti-noise 260. Accordingly, mobile robot device 265 may cancel or minimize the first frequency from noise 255 while permitting the second frequency from sound 293. In some examples, mobile robot device 205 or mobile robot device 265 may provide noise canceling in a hospital setting. In some examples, mobile robot device 205 or mobile robot device 265 may provide noise canceling at certain times of a day (e.g., during a configured sleep time such as from 10:00 PM to 6:00 AM). In some examples, mobile robot device 205 or mobile robot device 265 may cancel certain noises (e.g., conversations, motor noises, vehicle noises) while not canceling other sounds (e.g., medical equipment, etc.).

In some examples, mobile robot device 265 may move around second room 250 based on the detection of noise 255. In some examples, mobile robot device 265 may generate anti-noise 260 to minimize or cancel noise 255. In some examples, mobile robot device 265 may change locations or directions, or both, based on an analysis of noise 255 to determine one or more aspects of noise 255 (e.g., location of noise 255, direction of noise 255, amplitude of noise 255, frequencies of noise 255, etc.). In some examples, mobile robot device 265 may avoid object 270 when moving around second room 250.

In some examples, mobile robot device 265 may detect noise 299 from second window 297. In some examples, mobile robot device 265 may adjust one or more aspects of anti-noise 260 (e.g., add a second frequency of anti-noise 260 to a first frequency of anti-noise 260, increase or decrease an amplitude of a frequency of anti-noise 260, etc.) based on the detection of noise 299. In some examples, mobile robot device 265 may adjust its location or direction, or both, based on the detection of noise 299.

Accordingly, mobile robot device 205 may enable one or more users (e.g., user 220, or user 220 and at least one additional user) to occupy the first room 210 (e.g., move around first room 210) relatively free from ambient noise of the area or space without the users having to wear noise-canceling headsets. In some examples, mobile robot device 205 may play audio (e.g., music, audio book, podcast, etc.) in addition to the anti-noise 240. Thus, mobile robot device 205 may enable at least user 220 to listen to the audio in a relatively noise-free environment despite ambient noise such as the noise 235.

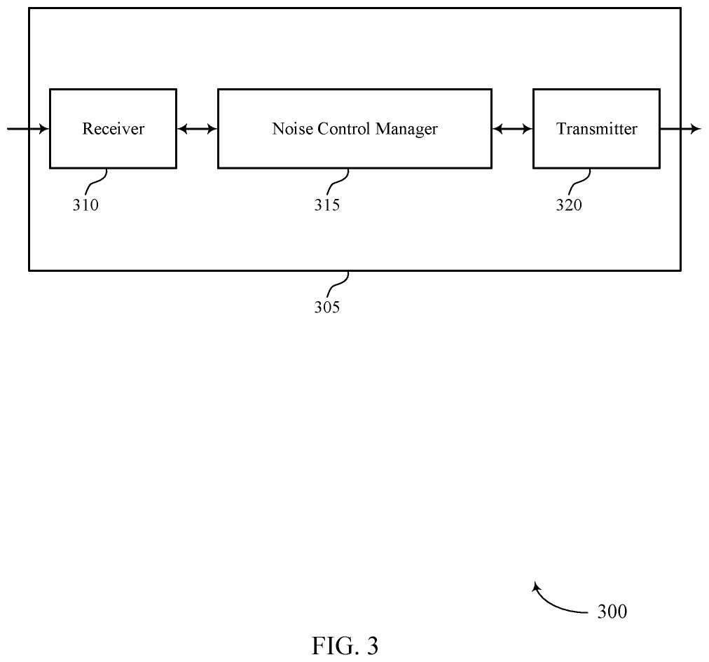

FIG. 3 shows a block diagram 300 of a device 305 that supports active noise control in accordance with aspects of the present disclosure. The device 305 may be an example of aspects of a device as described herein. The device 305 may include a receiver 310, a noise control manager 315, and a transmitter 320. The device 305 may also include a processor. Each of these components may be in communication with one another (e.g., via one or more buses).

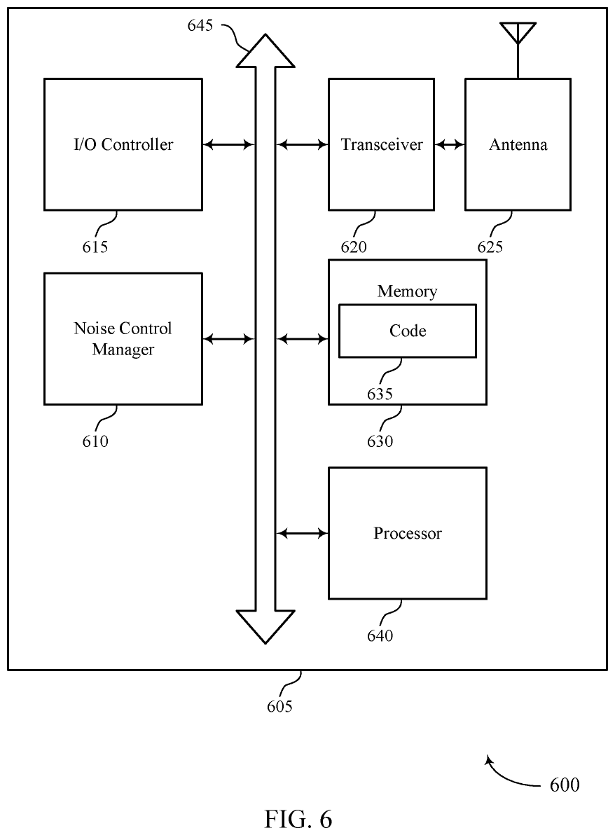

The receiver 310 may receive information such as packets, user data, or control information associated with various information channels (e.g., control channels, data channels, and information related to active noise control, etc.). Information may be passed on to other components of the device 305. The receiver 310 may be an example of aspects of the transceiver 620 described with reference to FIG. 6. The receiver 310 may utilize a single antenna or a set of antennas.

The noise control manager 315 may detect ambient noise via one or more microphones of the mobile robot device, determine that the ambient noise satisfies a threshold by comparing one or more parameters of the ambient noise to the threshold based on detecting of the noise parameter, generate anti-noise based on determining that the ambient noise satisfies the threshold, and broadcast the anti-noise in a first direction using one or more speakers of the mobile robot device. The noise control manager 315 may be an example of aspects of the noise control manager 610 described herein.

The noise control manager 315, or its sub-components, may be implemented in hardware, code (e.g., software or firmware) executed by a processor, or any combination thereof. If implemented in code executed by a processor, the functions of the noise control manager 315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The noise control manager 315, or its sub-components, may be physically located at various positions, including being distributed such that portions of functions are implemented at different physical locations by one or more physical components. In some examples, the noise control manager 315, or its sub-components, may be a separate and distinct component in accordance with various aspects of the present disclosure. In some examples, the noise control manager 315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 320 may transmit signals generated by other components of the device 305. In some examples, the transmitter 320 may be collocated with a receiver 310 in a transceiver module. For example, the transmitter 320 may be an example of aspects of the transceiver 620 described with reference to FIG. 6. The transmitter 320 may utilize a single antenna or a set of antennas.

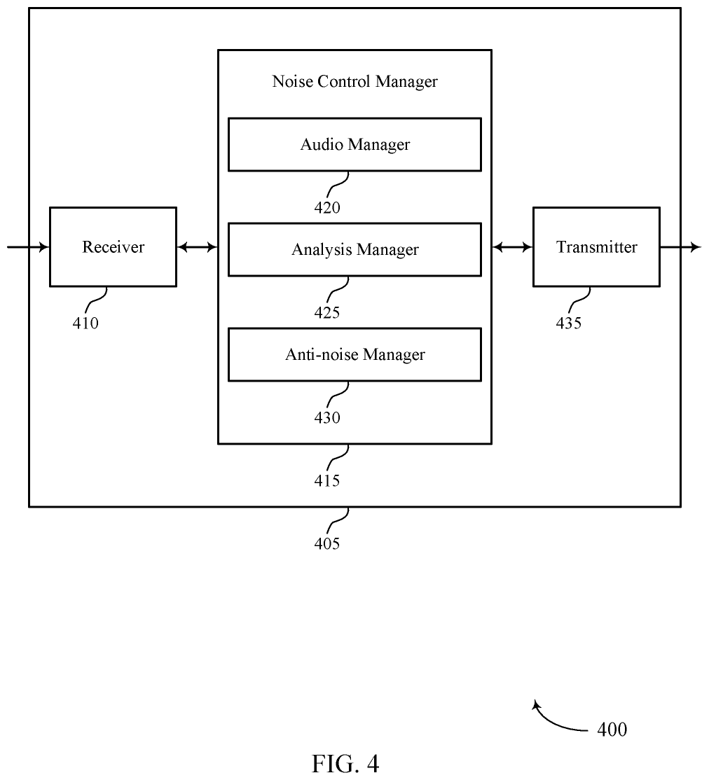

FIG. 4 shows a block diagram 400 of a device 405 that supports active noise control in accordance with aspects of the present disclosure. The device 405 may be an example of aspects of a device 305 or a device 115 as described herein. The device 405 may include a receiver 410, a noise control manager 415, and a transmitter 435. The device 405 may also include a processor. Each of these components may be in communication with one another (e.g., via one or more buses).

The receiver 410 may receive information such as packets, user data, or control information associated with various information channels (e.g., control channels, data channels, and information related to active noise control, etc.). Information may be passed on to other components of the device 405. The receiver 410 may be an example of aspects of the transceiver 620 described with reference to FIG. 6. The receiver 410 may utilize a single antenna or a set of antennas.

The noise control manager 415 may be an example of aspects of the noise control manager 315 as described herein. The noise control manager 415 may include an audio manager 420, an analysis manager 425, and an anti-noise manager 430. The noise control manager 415 may be an example of aspects of the noise control manager 610 described herein.

The audio manager 420 may detect ambient noise via one or more microphones of the mobile robot device.

The analysis manager 425 may determine that the ambient noise satisfies a threshold by comparing one or more parameters of the ambient noise to the threshold based on detecting of the noise parameter.

The anti-noise manager 430 may generate anti-noise based on determining that the ambient noise satisfies the threshold and broadcast the anti-noise in a first direction using one or more speakers of the mobile robot device.

The transmitter 435 may transmit signals generated by other components of the device 405. In some examples, the transmitter 435 may be collocated with a receiver 410 in a transceiver module. For example, the transmitter 435 may be an example of aspects of the transceiver 620 described with reference to FIG. 6. The transmitter 435 may utilize a single antenna or a set of antennas.

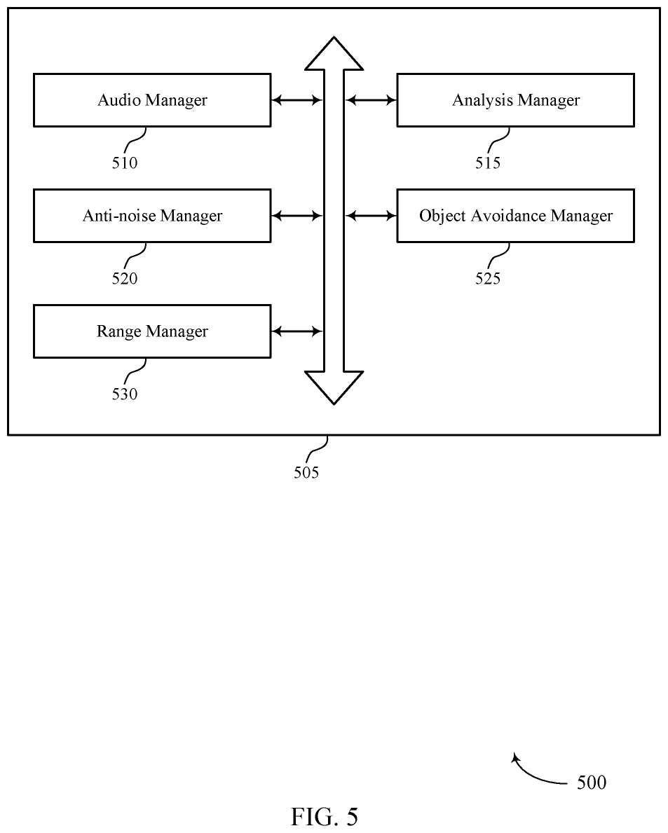

FIG. 5 shows a block diagram 500 of a noise control manager 505 that supports active noise control in accordance with aspects of the present disclosure. The noise control manager 505 may be an example of aspects of a noise control manager 315, a noise control manager 415, or a noise control manager 610 described herein. The noise control manager 505 may include an audio manager 510, an analysis manager 515, an anti-noise manager 520, an object avoidance manager 525, and a range manager 530. Each of these modules may communicate, directly or indirectly, with one another (e.g., via one or more buses).

The audio manager 510 may detect ambient noise via one or more microphones of the mobile robot device. In some cases, the mobile robot device may be an aerial drone. In some cases, the one or more speakers may include wireless speakers.

The analysis manager 515 may determine that the ambient noise satisfies a threshold by comparing one or more parameters of the ambient noise to the threshold based on detecting of the noise parameter.

The anti-noise manager 520 may generate anti-noise based on determining that the ambient noise satisfies the threshold. In some examples, the anti-noise manager 520 may broadcast the anti-noise in a first direction using one or more speakers of the mobile robot device. In some examples, the anti-noise manager 520 may broadcast audio concurrent with broadcasting the anti-noise using the one or more speakers of the mobile robot device.

In some examples, the audio manager 510 may detect a change in a signal strength of the ambient noise. In some examples, the anti-noise manager 520 may adjust a signal strength of the anti-noise based on the detected change in the signal strength of the ambient noise. In some examples, the anti-noise manager 510 may broadcast the anti-noise in a second direction based on the change in the location of the ambient noise.

In some examples, the analysis manager 515 may analyze a first signal of the ambient noise detected by a first microphone of the one or more microphones relative to a second signal of the ambient noise detected by a second microphone of the one or more microphones.

In some examples, the analysis manager 515 may determine a location of the ambient noise relative to the mobile robot device based on the analyzing of the first signal relative to the second signal, where generating the anti-noise is based on determining the location of the ambient noise.

In some examples, the analysis manager 515 may determine a change in the location of the ambient noise. The object avoidance manager 525 may detect, via a sensor on the mobile robot device, an object. In some examples, the object avoidance manager 525 may avoid, based on the detecting, a collision between the mobile robot device and the object when adjusting a position of the mobile robot device in relation to the first direction.

The range manager 530 may maintain a determined range between the mobile robot device and a mobile computing device or between the mobile robot device and a user of the mobile computing device when adjusting a position of the mobile robot device in relation to the first direction.

In some examples, the range manager 530 may determine, in conjunction with a sensor of the mobile robot device (e.g., a camera on the mobile robot device), a face of the user or an identity of the user, or both. In some examples, the range manager 530 may maintain the determined range between the mobile robot device and the user based on the determining.

FIG. 6 shows a diagram of a system 600 including a device 605 that supports active noise control in accordance with aspects of the present disclosure. The device 605 may be an example of or include the components of device 305, device 405, or a device as described herein. The device 605 may include components for bi-directional voice and data communications including components for transmitting and receiving communications, including a noise control manager 610, an I/O controller 615, a transceiver 620, an antenna 625, memory 630, a processor 640, and a coding manager 650. These components may be in electronic communication via one or more buses (e.g., bus 645).

The noise control manager 610 may detect ambient noise via one or more microphones of the mobile robot device, determine that the ambient noise satisfies a threshold by comparing one or more parameters of the ambient noise to the threshold based on detecting of the noise parameter, generate anti-noise based on determining that the ambient noise satisfies the threshold, and broadcast the anti-noise in a first direction using one or more speakers of the mobile robot device.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described herein. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some cases, the wireless device may include a single antenna 625. However, in some cases the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting active noise control).

The code 635 may include instructions to implement aspects of the present disclosure, including instructions to support active noise control. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

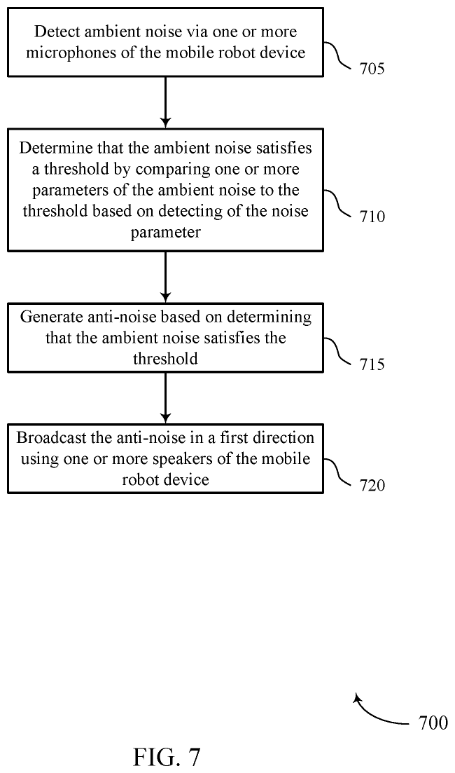

FIG. 7 shows a flowchart illustrating a method 700 that supports active noise control in accordance with aspects of the present disclosure. The operations of method 700 may be implemented by a device or its components as described herein. For example, the operations of method 700 may be performed by a noise control manager as described with reference to FIGS. 3 through 6. In some examples, a device may execute a set of instructions to control the functional elements of the device to perform the functions described herein. Additionally or alternatively, a device may perform aspects of the functions described herein using special-purpose hardware.

At 705, the device may detect ambient noise via one or more microphones of the mobile robot device. The operations of 705 may be performed according to the methods described herein. In some examples, aspects of the operations of 705 may be performed by an audio manager as described with reference to FIGS. 3 through 6.

At 710, the device may determine that the ambient noise satisfies a threshold by comparing one or more parameters of the ambient noise to the threshold based on detecting of the noise parameter. The operations of 710 may be performed according to the methods described herein. In some examples, aspects of the operations of 710 may be performed by an analysis manager as described with reference to FIGS. 3 through 6.

At 715, the device may generate anti-noise based on determining that the ambient noise satisfies the threshold. The operations of 715 may be performed according to the methods described herein. In some examples, aspects of the operations of 715 may be performed by an anti-noise manager as described with reference to FIGS. 3 through 6.

At 720, the device may broadcast the anti-noise in a first direction using one or more speakers of the mobile robot device. The operations of 720 may be performed according to the methods described herein. In some examples, aspects of the operations of 720 may be performed by an anti-noise manager as described with reference to FIGS. 3 through 6.

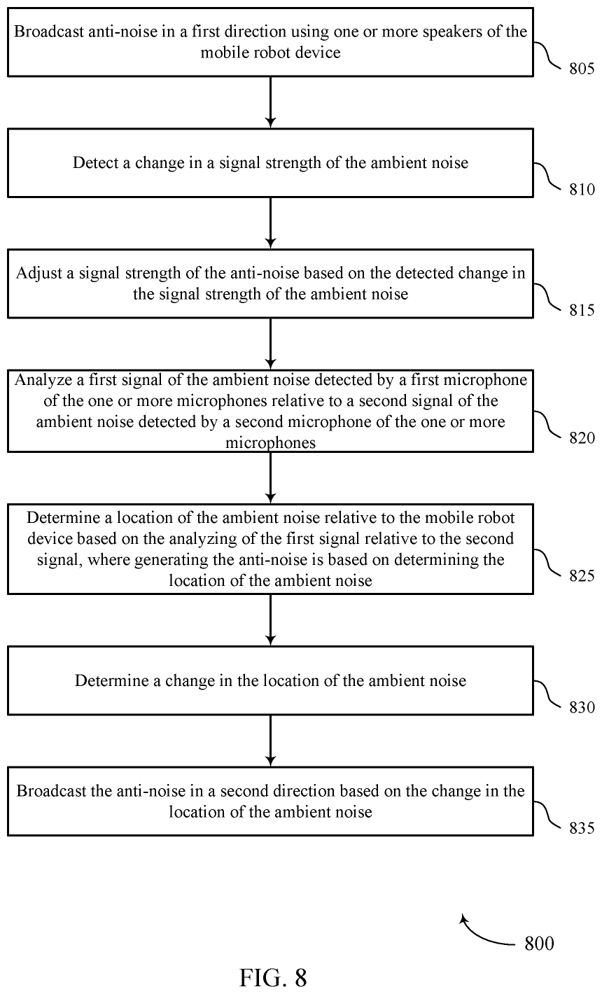

FIG. 8 shows a flowchart illustrating a method 800 that supports active noise control in accordance with aspects of the present disclosure. The operations of method 800 may be implemented by a device or its components as described herein. For example, the operations of method 800 may be performed by a noise control manager as described with reference to FIGS. 3 through 6. In some examples, a device may execute a set of instructions to control the functional elements of the device to perform the functions described herein. Additionally or alternatively, a device may perform aspects of the functions described herein using special-purpose hardware.

At 805, a device may broadcast anti-noise in a first direction using one or more speakers of the device based at least in part on ambient noise detected by the device. The operations of 805 may be performed according to the methods described herein. In some examples, aspects of the operations of 805 may be performed by an anti-noise manager as described with reference to FIGS. 3 through 6.

At 810, the device may detect a change in a signal strength of the ambient noise. The operations of 810 may be performed according to the methods described herein. In some examples, aspects of the operations of 810 may be performed by an audio manager as described with reference to FIGS. 3 through 6.

At 815, the device may adjust a signal strength of the anti-noise based on the detected change in the signal strength of the ambient noise. The operations of 815 may be performed according to the methods described herein. In some examples, aspects of the operations of 815 may be performed by an anti-noise2 manager as described with reference to FIGS. 3 through 6.

At 820, the device may analyze a first signal of the ambient noise detected by a first microphone of one or more microphones of the device relative to a second signal of the ambient noise detected by a second microphone of the one or more microphones. The operations of 820 may be performed according to the methods described herein. In some examples, aspects of the operations of 820 may be performed by an analysis2 manager as described with reference to FIGS. 3 through 6.

At 825, the device may determine a location of the ambient noise relative to the device based on the analyzing of the first signal relative to the second signal, where generating the anti-noise is based on determining the location of the ambient noise. The operations of 825 may be performed according to the methods described herein. In some examples, aspects of the operations of 825 may be performed by an analysis2 manager as described with reference to FIGS. 3 through 6.

At 830, the device may determine a change in the location of the ambient noise. The operations of 830 may be performed according to the methods described herein. In some examples, aspects of the operations of 830 may be performed by an analysis2 manager as described with reference to FIGS. 3 through 6.

At 835, the device may broadcast the anti-noise in a second direction based on the change in the location of the ambient noise. The operations of 835 may be performed according to the methods described herein. In some examples, aspects of the operations of 835 may be performed by an anti-noise2 manager as described with reference to FIGS. 3 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for active noise control associated with a mobile robot device, comprising:
detecting ambient noise via one or more microphones of the mobile robot device;
determining that the ambient noise satisfies a threshold by comparing one or more parameters of the ambient noise to the threshold based at least in part on detecting of the noise parameter;
generating anti-noise based at least in part on determining that the ambient noise satisfies the threshold; and
broadcasting the anti-noise in a first direction using one or more speakers of the mobile robot device.

2. The method of claim 1, further comprising:
detecting a change in a signal strength of the ambient noise; and
adjusting a signal strength of the anti-noise based at least in part on the detected change in the signal strength of the ambient noise.

3. The method of claim 2, further comprising:
analyzing a first signal of the ambient noise detected by a first microphone of the one or more microphones relative to a second signal of the ambient noise detected by a second microphone of the one or more microphones; and
determining a location of the ambient noise relative to the mobile robot device based at least in part on the analyzing of the first signal relative to the second signal, wherein generating the anti-noise is based at least in part on determining the location of the ambient noise.

4. The method of claim 3, further comprising:
determining a change in the location of the ambient noise; and
broadcasting the anti-noise in a second direction based at least in part on the change in the location of the ambient noise.

5. The method of claim 1, further comprising:
detecting, via a sensor on the mobile robot device, an object; and
avoiding, based at least in part on the detecting, a collision between the mobile robot device and the object when adjusting a position of the mobile robot device in relation to the first direction.

6. The method of claim 1, further comprising:
maintaining a determined range between the mobile robot device and a mobile computing device or between the mobile robot device and a user of the mobile computing device when adjusting a position of the mobile robot device in relation to the first direction.

7. The method of claim 6, further comprising:
determining, via a camera on the mobile robot device, a face of the user or an identity of the user, or both; and
maintaining the determined range between the mobile robot device and the user based at least in part on the determining.

8. The method of claim 1, further comprising:
broadcasting audio concurrent with broadcasting the anti-noise using the one or more speakers of the mobile robot device.

9. The method of claim 1, wherein the mobile robot device is an aerial drone.

10. The method of claim 1, wherein the one or more speakers include wireless speakers.

11. An apparatus for active noise control associated with the apparatus, comprising:
a processor,
memory coupled with the processor; and
instructions stored in the memory and executable by the processor to cause the apparatus to:
detect ambient noise via one or more microphones of the apparatus;
determine that the ambient noise satisfies a threshold by comparing one or more parameters of the ambient noise to the threshold based at least in part on detecting of the noise parameter;
generate anti-noise based at least in part on determining that the ambient noise satisfies the threshold; and
broadcast the anti-noise in a first direction using one or more speakers of the apparatus.

12. The apparatus of claim 11, wherein the instructions are further executable by the processor to cause the apparatus to:
detect a change in a signal strength of the ambient noise; and
adjust a signal strength of the anti-noise based at least in part on the detected change in the signal strength of the ambient noise.

13. The apparatus of claim 12, wherein the instructions are further executable by the processor to cause the apparatus to:
analyze a first signal of the ambient noise detected by a first microphone of the one or more microphones relative to a second signal of the ambient noise detected by a second microphone of the one or more microphones; and
determine a location of the ambient noise relative to the apparatus based at least in part on the analyzing of the first signal relative to the second signal, wherein generating the anti-noise is based at least in part on determining the location of the ambient noise.

14. The apparatus of claim 13, wherein the instructions are further executable by the processor to cause the apparatus to:
determine a change in the location of the ambient noise; and
broadcast the anti-noise in a second direction based at least in part on the change in the location of the ambient noise.

15. The apparatus of claim 11, wherein the instructions are further executable by the processor to cause the apparatus to:
detect, via a sensor on the apparatus, an object; and
avoid, based at least in part on the detecting, a collision between the apparatus and the object when adjusting a position of the apparatus in relation to the first direction.

16. The apparatus of claim 11, wherein the instructions are further executable by the processor to cause the apparatus to:
maintain a determined range between the apparatus and a mobile computing device or between the apparatus and a user of the mobile computing device when adjusting a position of the apparatus in relation to the first direction.

17. The apparatus of claim 16, wherein the instructions are further executable by the processor to cause the apparatus to:
determine, via a camera on the apparatus, a face of the user or an identity of the user, or both; and
maintain the determined range between the apparatus and the user based at least in part on the determining.

18. The apparatus of claim 11, wherein the instructions are further executable by the processor to cause the apparatus to:
broadcast audio concurrent with broadcasting the anti-noise using the one or more speakers of the apparatus.

19. A non-transitory computer-readable medium storing code for active noise control associated with a mobile robot device, the code comprising instructions executable by a processor to:
detect ambient noise via one or more microphones of the mobile robot device;
determine that the ambient noise satisfies a threshold by comparing one or more parameters of the ambient noise to the threshold based at least in part on detecting of the noise parameter;
generate anti-noise based at least in part on determining that the ambient noise satisfies the threshold; and
broadcast the anti-noise in a first direction using one or more speakers of the mobile robot device.

20. The non-transitory computer-readable medium of claim 19, wherein the instructions are further executable to:
detect a change in a signal strength of the ambient noise; and
adjust a signal strength of the anti-noise based at least in part on the detected change in the signal strength of the ambient noise.
